(19) United States
(12) Patent Application Publication
(10) Pub. No.: US 2026/0140374 A1
(43) Pub. Date: May 21, 2026

(54) HEAD-MOUNTED DISPLAY DEVICE AND FACE GASKET

(71) Applicant: HTC Corporation, Taoyuan City (TW)

(72) Inventor: Meng Yu Jian, Taoyuan City (TW)

(73) Assignee: HTC Corporation, Taoyuan City (TW)

(21) Appl. No.: 18/950,175

(22) Filed: Nov. 18, 2024

Related U.S. Application Data
(60) Provisional application No. 63/633,860, filed on Apr. 15, 2024.

(51) Int. Cl. G02B 27/01

(52) U.S. Cl. CPC G02B 27/0149

(57) ABSTRACT

A head-mounted display device including a display part and a face gasket is provided. The face gasket includes a frame and a pad. The frame is connected to the display part. The pad extends from a user's forehead, around user's eyes, and to user's cheeks, and has a pair of forehead connecting segments and a pair of cheek connecting segments. The pair of forehead connecting segments respectively correspond to user's eyebrows and are each connected to the pad and rotatably connected to the frame with at least one rotational degree of freedom. The pair of cheek connecting segments respectively correspond to the user's cheeks and are each connected to the pad and rotatably connected to the frame with at least one rotational degree of freedom. Here, a face gasket is also provided.

### CROSS-REFERENCE TO RELATED APPLICATION

This application claims the priority benefit of U.S. provisional application Ser. No. 63/633,860, filed on Apr. 15, 2024. The entirety of the above-mentioned patent application is hereby incorporated by reference herein and made a part of this specification.

### BACKGROUND

### Technical Field

The disclosure relates to a display device, and particularly relates to a head-mounted display device and a face gasket applicable to the head-mounted display device.

### Description of Related Art

As the technology industry continues to flourish and advance, the types, functions, and methods of use of display devices are becoming increasingly diverse, and head-mounted display devices that may be worn directly on the user's head have also emerged accordingly. After the user wears the head-mounted display device, in addition to seeing three-dimensional images, the image will also change as the user's head rotates, providing the user with a more immersive experience. The head-mounted display device may secure its display part in front of the user's eyes via its face gasket. However, users'face shapes are not exactly the same, which makes it difficult for a single-design face gasket to adapt to users with different face shapes.

### SUMMARY

The disclosure provides a head-mounted display device whose face gasket may adapt to users with different face shapes.

The disclosure provides a face gasket adapted for a head-mounted display device, which may adapt to users with different face shapes.

A head-mounted display device of the disclosure includes a display part and a face gasket. The face gasket includes a frame and a pad. The frame is connected to the display part. The pad extends from a user's forehead, around user's eyes, and to user's cheeks, and has a pair of forehead connecting segments and a pair of cheek connecting segments. The pair of forehead connecting segments respectively correspond to user's eyebrows and are each connected to the pad and rotatably connected to the frame with at least one rotational degree of freedom, and the pair of cheek connecting segments respectively correspond to the user's cheeks and are each connected to the pad and rotatably connected to the frame with at least one rotational degree of freedom.

A face gasket of the disclosure is adapted for a head-mounted display device. The head-mounted display device includes a display part. The face gasket includes a frame and a pad. The frame is connected to the display part. The pad extends from a user's forehead, around user's eyes, and to user's cheeks, and has a pair of forehead connecting segments and a pair of cheek connecting segments. The pair of forehead connecting segments respectively correspond to user's eyebrows and are each connected to the pad and rotatably connected to the frame with at least one rotational degree of freedom, and the pair of cheek connecting segments respectively correspond to the user's cheeks and are each connected to the pad and rotatably connected to the frame with at least one rotational degree of freedom.

Based on the above, in the disclosure, the pair of forehead connecting segments and the pair of cheek connecting segments of the pad of the face gasket may each rotate relative to the frame to adapt to the face shapes of different users.

### BRIEF DESCRIPTION OF THE DRAWINGS

FIG. 1A is a schematic view of the forehead contours of various users.

FIG. 1B is a schematic view of the cheek contours of various users.

FIG. 2 is a schematic view of a head-mounted display device according to an embodiment of the invention.

FIG. 3A is a schematic three-dimensional view of the frame and pad depicted in FIG. 2.

FIG. 3B is a schematic three-dimensional view of the frame and pad depicted in FIG. 2 in a deformed state.

FIG. 4A is a schematic top view of the frame and pad depicted in FIG. 2.

FIG. 4B is a schematic top view of the frame and pad depicted in FIG. 2 in a deformed state.

FIG. 5A is a schematic bottom view of the frame and pad depicted in FIG. 2.

FIG. 5B is a schematic bottom view of the frame and pad depicted in FIG. 2 in a deformed state.

FIG. 6 is an exploded view of the face gasket depicted in FIG. 3A.

FIG. 7 is an exploded view of the face gasket depicted in FIG. 3A from another perspective.

FIG. 8 is a schematic view of a part of components of a head-mounted display device according to another embodiment of the invention.

FIG. 9 is a schematic view of a head-mounted display device according to another embodiment of the invention.

FIG. 10 is a schematic three-dimensional view of the frame and pad of the head-mounted display device according to another embodiment of the invention.

FIG. 11A is a schematic top view of the frame and pad depicted in FIG. 10.

FIG. 11B is a schematic top view of the frame and pad depicted in FIG. 10 in a deformed state.

FIG. 12A is a schematic bottom view of the frame and pad depicted in FIG. 10.

FIG. 12B is a schematic bottom view of the frame and pad depicted in FIG. 10 in a deformed state.

FIG. 13 is an exploded view of the face gasket depicted in FIG. 10.

FIG. 14 is an exploded view of the face gasket depicted in FIG. 10 from another perspective.

### DESCRIPTION OF THE EMBODIMENTS

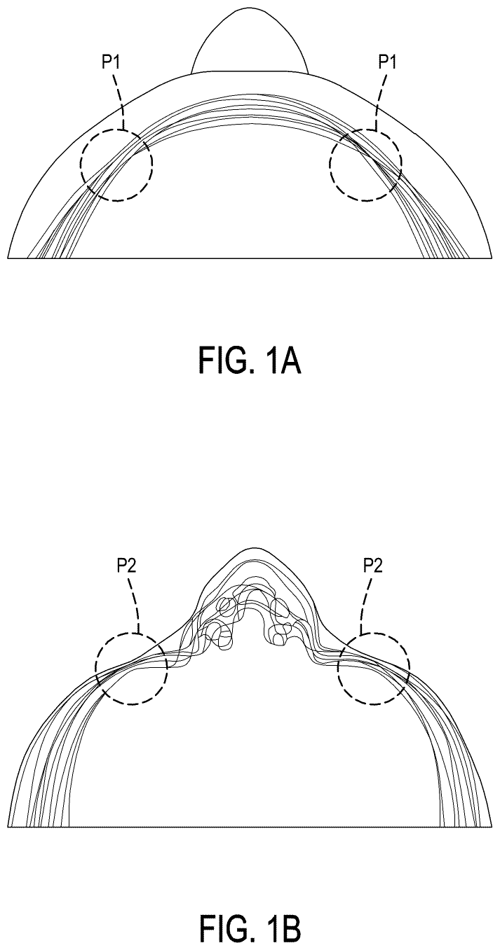

Referring to FIG. 1A and FIG. 1B, FIG. 1A and FIG. 1B simultaneously present the contour lines of various users'heads at the forehead and cheek positions. Although the contour lines of the forehead and cheeks of different users vary to varying degrees, the positions on the forehead and cheeks where these contour lines almost all pass through may still be identified, such as the two circles P1 in FIG. 1A and the two circles P2 in FIG. 1B.

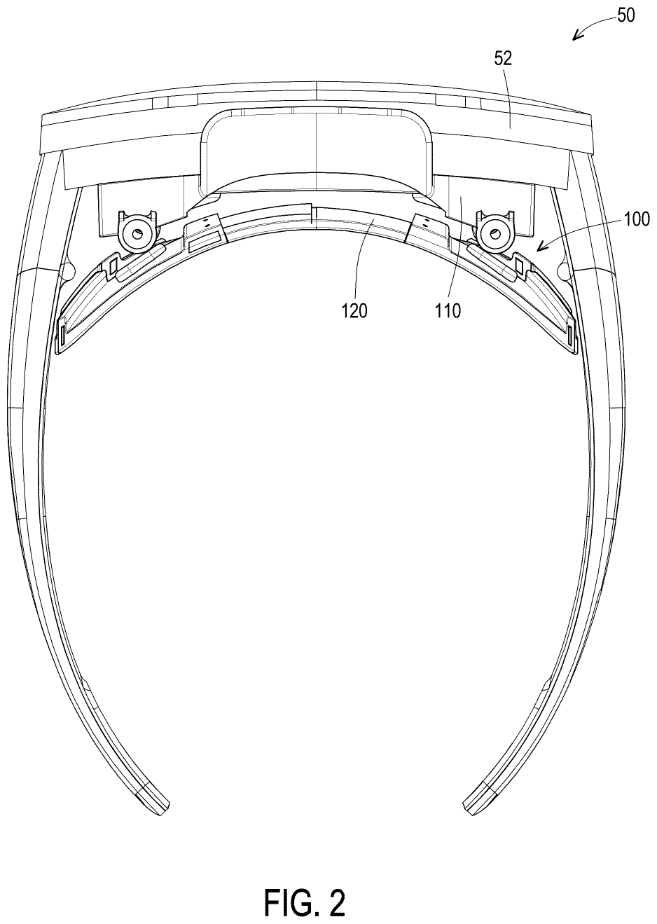

Referring to FIG. 2, in the embodiment, a head-mounted display device 50 includes a display part 52 and a face gasket 100. The face gasket 100 is used to secure the display part 52 in front of the user's eyes. The face gasket 100 includes a frame 110 and a pad 120. The frame 110 is connected to the display part 52. For example, the frame 110 may be connected to the display part 52 through methods such as snapping, fastening, magnetic attraction, or integrated molding. In addition, the pad 120 extends from a user's forehead, around user's eyes, and to user's cheeks.

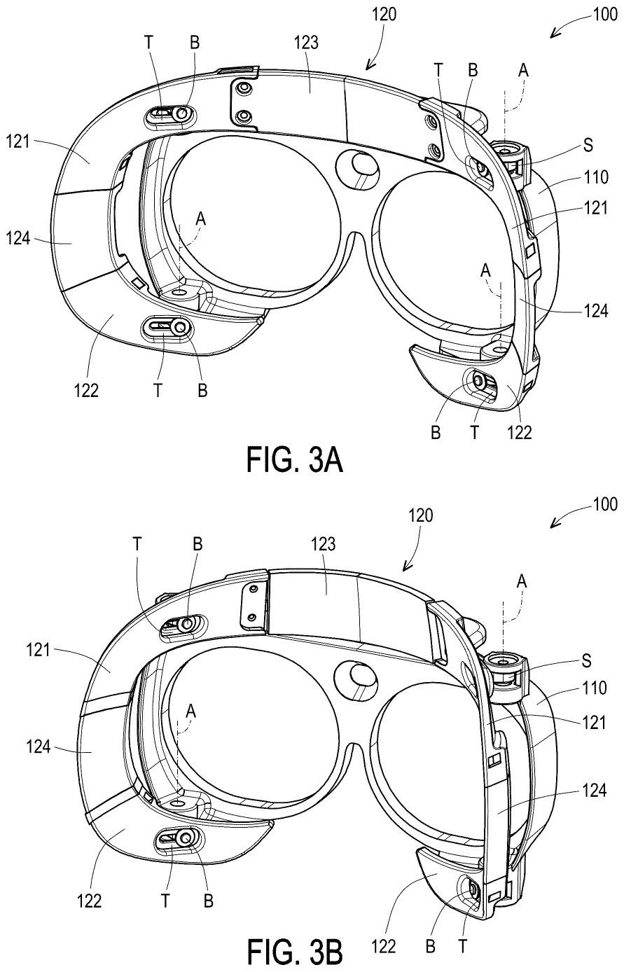

Referring to FIG. 3A, in the embodiment, the pad 120 has a pair of forehead connecting segments 121 and a pair of cheek connecting segments 122. The pair of forehead connecting segments 121 respectively correspond to the user's eyebrows (the two circles P1 in FIG. 1A) and are each connected to the pad 120 and rotatably connected to the frame 110 with at least one rotational degree of freedom. The pair of cheek connecting segments 122 respectively correspond to the user's cheeks (the two circles P2 in FIG. 1B) and are each connected to the pad 120 and rotatably connected to the frame 110 with at least one rotational degree of freedom.

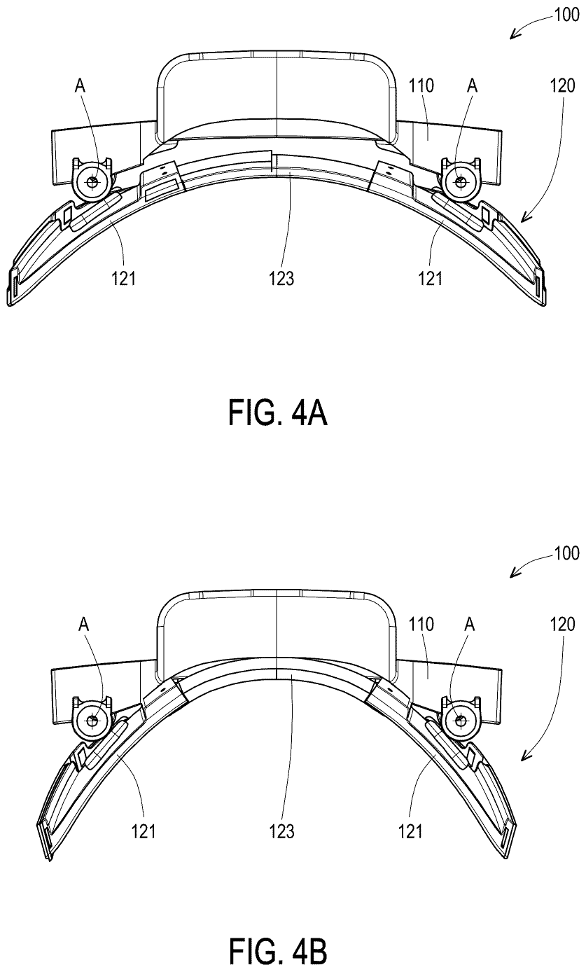

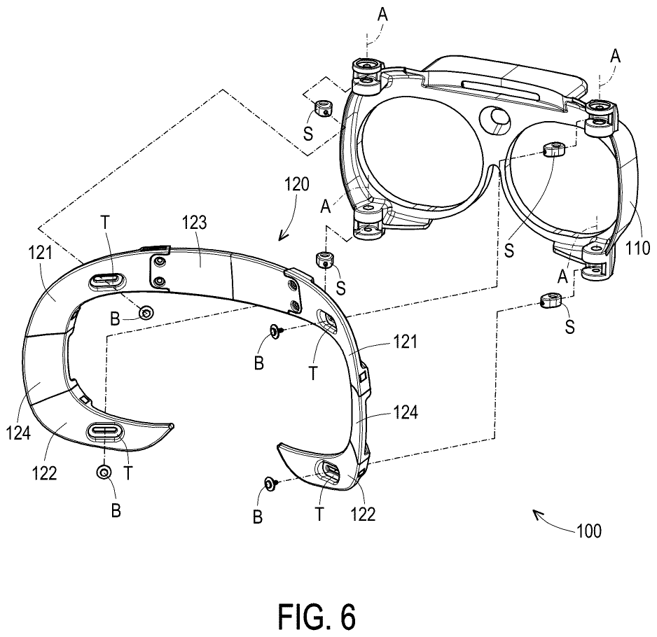

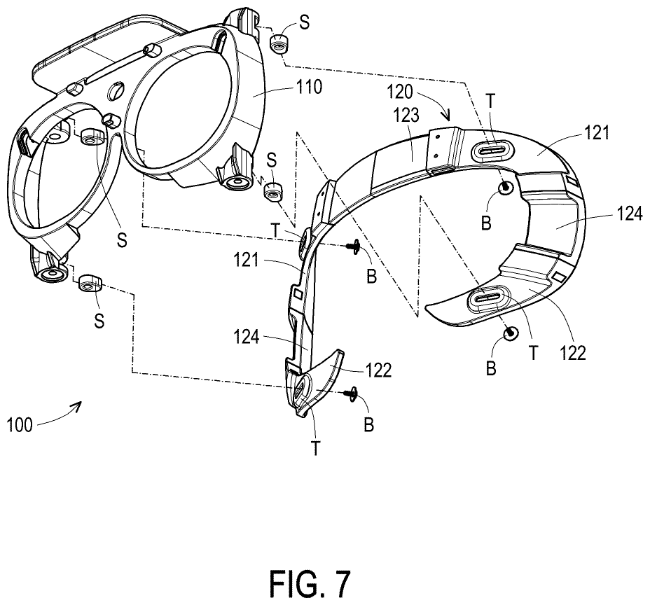

Referring to FIG. 3A, FIG. 3B, FIG. 4A, and FIG. 4B, in the embodiment, the pair of forehead connecting segments 121 may rotate relative to the frame 110 on two axes A respectively, so that the pad 120 may be adaptive to the user's forehead. For example, each of the pair of forehead connecting segments 121 may be rotatably connected to the frame 110 via a rotary shaft S (as shown in FIG. 6 and FIG. 7), but the disclosure is not limited thereto.

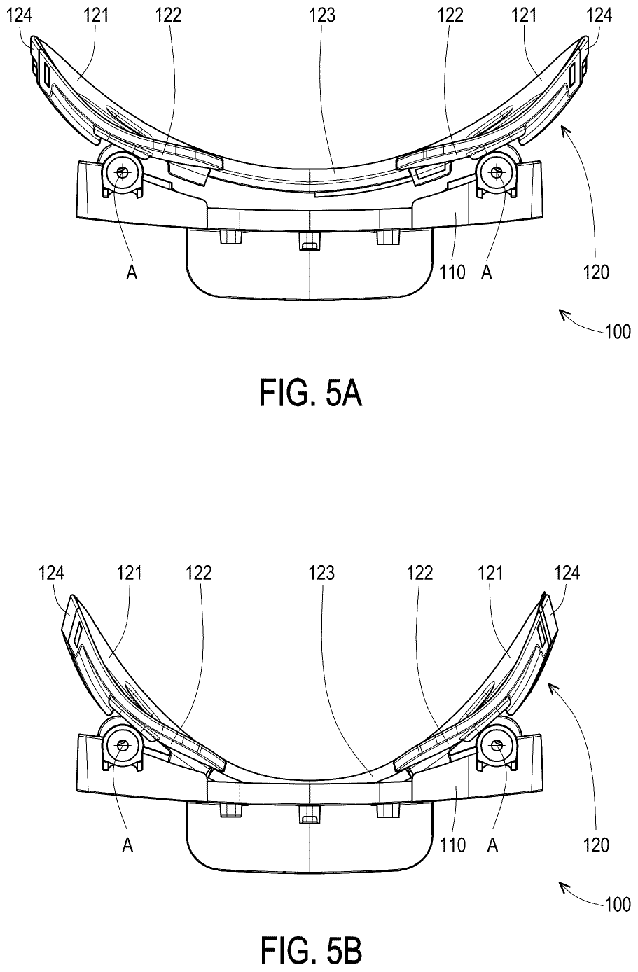

Referring to FIG. 3A, FIG. 3B, FIG. 5A, and FIG. 5B, in the embodiment, the pair of cheek connecting segments 122 may rotate on two axes A respectively relative to the frame 110, so that the pad 120 may be adaptive to the user's cheeks. For example, each of the pair of cheek connecting segments 122 may be rotatably connected to the frame 110 via the rotary shaft S (as shown in FIG. 6 and FIG. 7), but the disclosure is not limited thereto.

Referring to FIG. 4A, FIG. 4B, FIG. 5A, and FIG. 5B, since each of the pair of forehead connecting segments 121 is movably connected to the frame 110 with one rotational degree of freedom via the rotary shaft S, and the pair of cheek connecting segments 122 is movably connected to the frame 110 with one rotational degree of freedom via the rotary shaft S, the upper and lower parts of the pad 120 may be respectively adaptive to the user's forehead and cheeks, thereby conforming to users with different face shapes. For example, the pad 120 of the embodiment may not only be adapted for users with larger head circumferences, as shown in FIG. 4A, but may also be adapted for users with smaller head circumferences, as shown in FIG. 4B. Similarly, the pad 120 of the embodiment may not only be adapted for users with larger cheeks, as shown in FIG. 5A, but may also be adapted for users with smaller cheeks, as shown in FIG. 5B.

Referring to FIG. 3A and FIG. 3B, in the embodiment, the pad 120 may further have a forehead flexible segment 123 and a pair of cheek flexible segments 124. The forehead flexible segment 123 is located between the pair of forehead connecting segments 121, and each of the pair of cheek flexible segments 124 is located at the corresponding forehead connecting segment 121 and the corresponding cheek connecting segment 122. Compared with the forehead flexible segment 123 and the pair of cheek flexible segments 124, the pair of forehead connecting segments 121 and the pair of cheek connecting segments 122 have lower flexibility and greater rigidity. Therefore, when the pair of forehead connecting segments 121 and the pair of cheek connecting segments 122 are stressed, a seesaw effect may be generated, causing the pair of forehead connecting segments 121 and the pair of cheek connecting segments 122 to rotate respectively, thereby twisting or bending the forehead flexible segment 123 and the pair of cheek flexible segments 124. Therefore, the pad 120 may be adaptive to the user's forehead and cheeks respectively, thereby conforming to users with different face shapes.

In the embodiment, the pair of forehead connecting segments 121, the pair of cheek connecting segments 122, the forehead flexible segment 123, and the pair of cheek flexible segments 124 may be manufactured individually and then assembled into the pad 120. In another embodiment not shown, the pair of forehead connecting segments 121, the pair of cheek connecting segments 122, the forehead flexible segment 123, and the pair of cheek flexible segments 124 may also be formed into the pad 120 through a double injection molding.

Referring to FIG. 3A, FIG. 6, and FIG. 7, in the embodiment, each of the pair of forehead connecting segments 121 may be movably connected to the frame 110 with another rotational degree of freedom and one translational degree of freedom. For example, each of the pair of forehead connecting segments 121 may have a slide rail T, and a bolt B passes through the slide rail T and is locked to the corresponding rotary shaft S, so that the sliding of the bolt B on the slide rail T adds another rotational degree of freedom and a translational degree of freedom between each forehead connecting segment 121 and the frame 110 to provide more margin when the pad 120 is deformed. Therefore, each forehead connecting segment 121 may be movably connected to the frame 110 with two rotational degrees of freedom and one translational degree of freedom through the rotary shaft S, the slide rail T, and the bolt B.

Referring to FIG. 3A, FIG. 6, and FIG. 7, in the embodiment, each of the pair of cheek connecting segments 122 may be movably connected to the frame 110 with another rotational degree of freedom and one translational degree of freedom. For example, each of the pair of cheek connecting segments 122 may have the slide rail T, and the bolt B passes through the slide rail T and is locked to the corresponding rotary shaft S, so that the sliding of the bolt B on the slide rail T adds another rotational degree of freedom and a translational degree of freedom between each cheek connecting segment 122 and the frame 110 to provide more margin when the pad 120 is deformed. Therefore, each cheek connecting segment 122 may be movably connected to the frame 110 with two rotational degrees of freedom and one translational degree of freedom through the rotary shaft S, the slide rail T, and the bolt B.

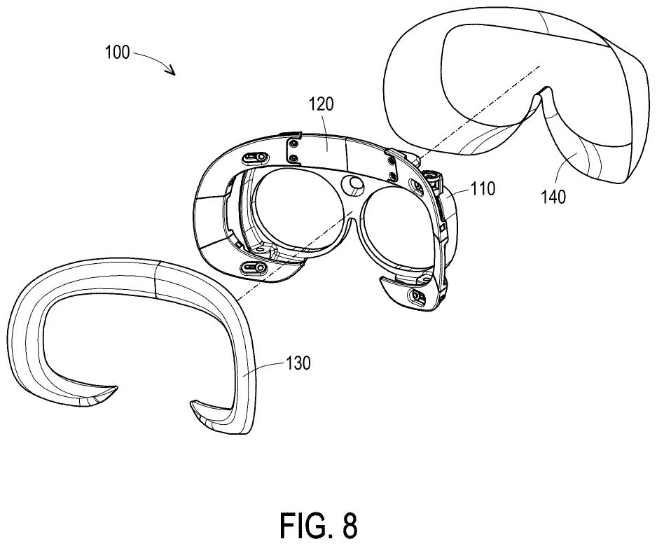

Referring to FIG. 8, in another embodiment, the face gasket 100 may further include a foam layer 130. The foam layer 130 is disposed on a side of the pad 120 close to the user's face to better conform to the user's face.

Referring to FIG. 8, in another embodiment, the face gasket 100 may further include a light shield 140. The light shield 140 is disposed between the frame 110 and the pad 120 to block external light from entering the user's field of view. In other words, the user may focus on viewing the image displayed on the display part 52 and avoid interference from external light.

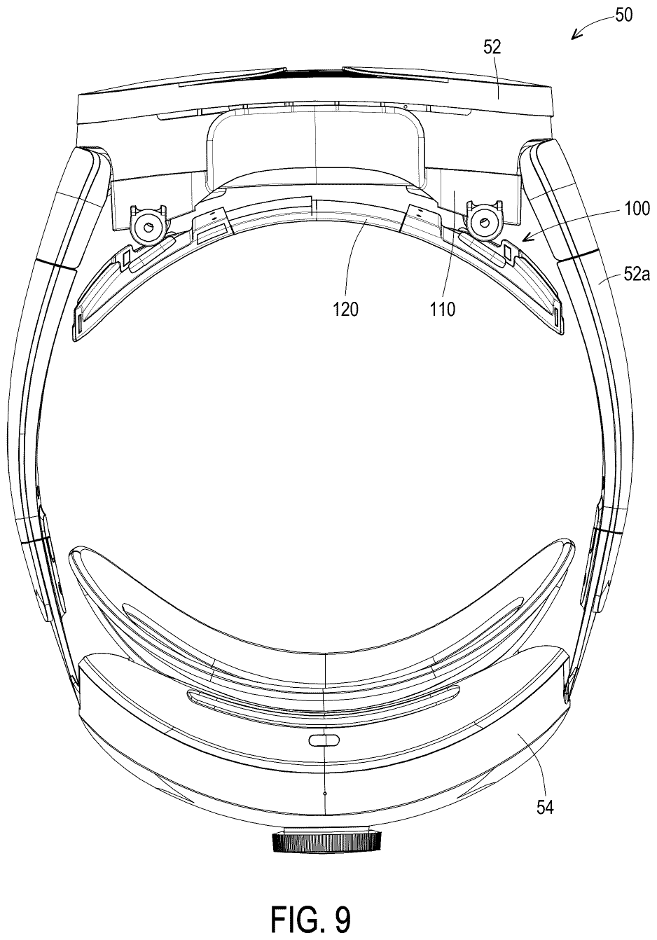

Referring to FIG. 9, in another embodiment, the head-mounted display device 50 may further include a headband module 54. The headband module 54 is connected to the display part 52 to position the display part 52 on the user's face. Specifically, both ends of the headband module 54 are detachably connected to a pair of brackets 52a of the display part 52 respectively. In another usage scenario, the headband module 54 may be detached from the display part 52. For example, when the user watches a video or performs other static activities, the headband module 54 may be detached to enjoy a lighter use experience since no strong fixing force is required. In other embodiments not shown, the bracket 52a may also be connected to other expanded functional components.

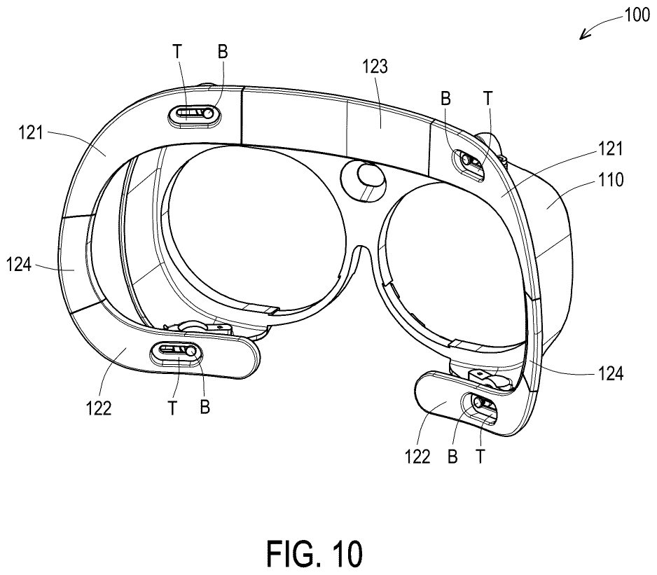

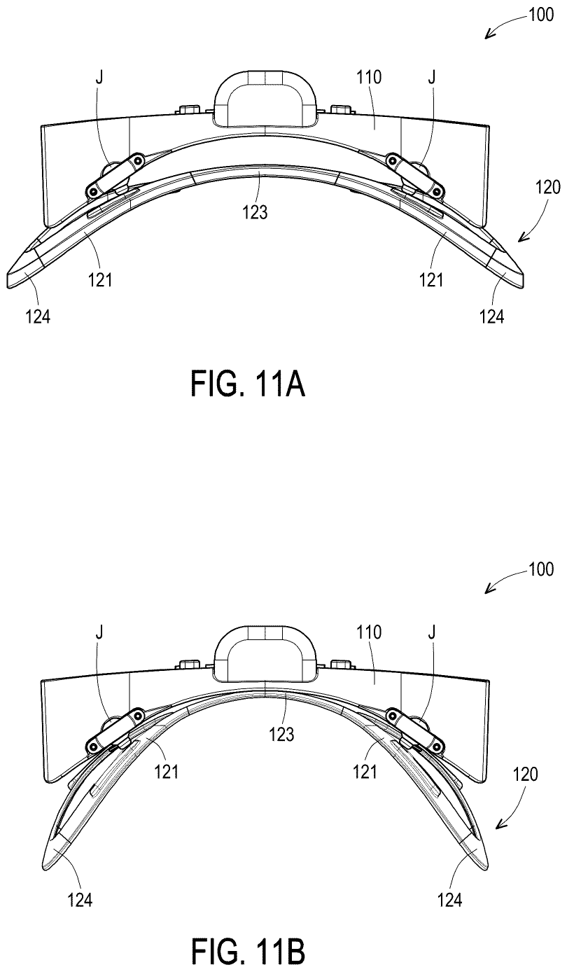

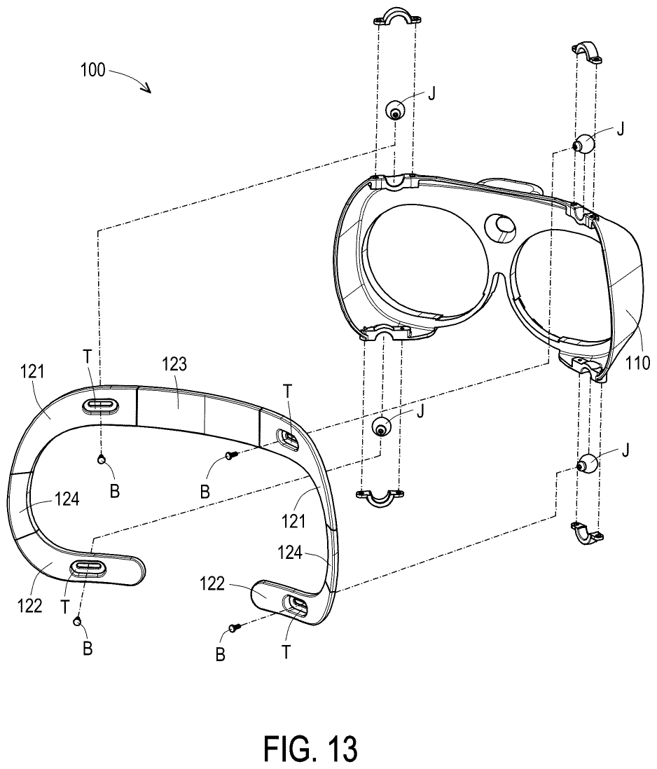

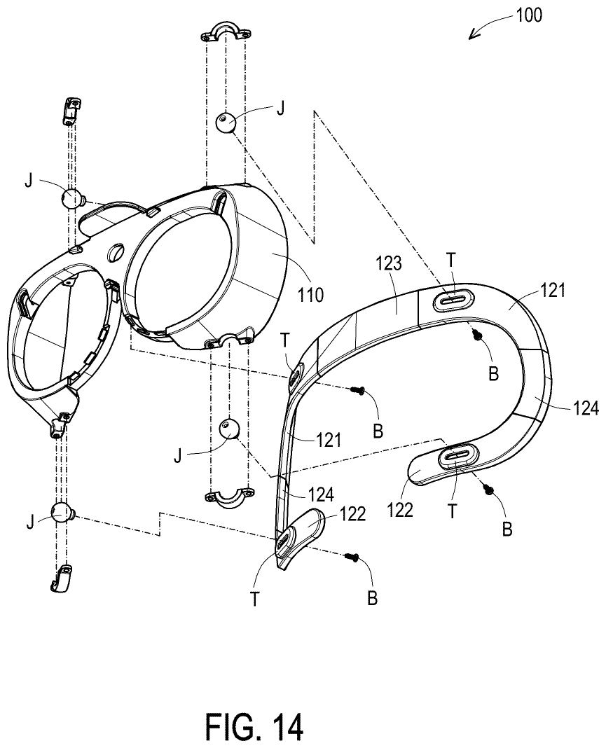

Referring to FIG. 10, FIG. 11A, and FIG. 11B, different from the forehead connecting segment 121 of the pad 120 depicted in FIG. 3A, which is connected to the frame 110 with one rotational degree of freedom, in another embodiment, each of the pair of forehead connecting segments 121 of the pad 120 is movably connected to the frame 110 with three rotational degrees of freedom, so that the pad 120 may be adaptive to the user's forehead. For example, each of the pair of forehead connecting segments 121 may be rotatably connected to the frame 110 via a ball joint J (as shown in FIG. 13 and FIG. 14), but the disclosure is not limited thereto.

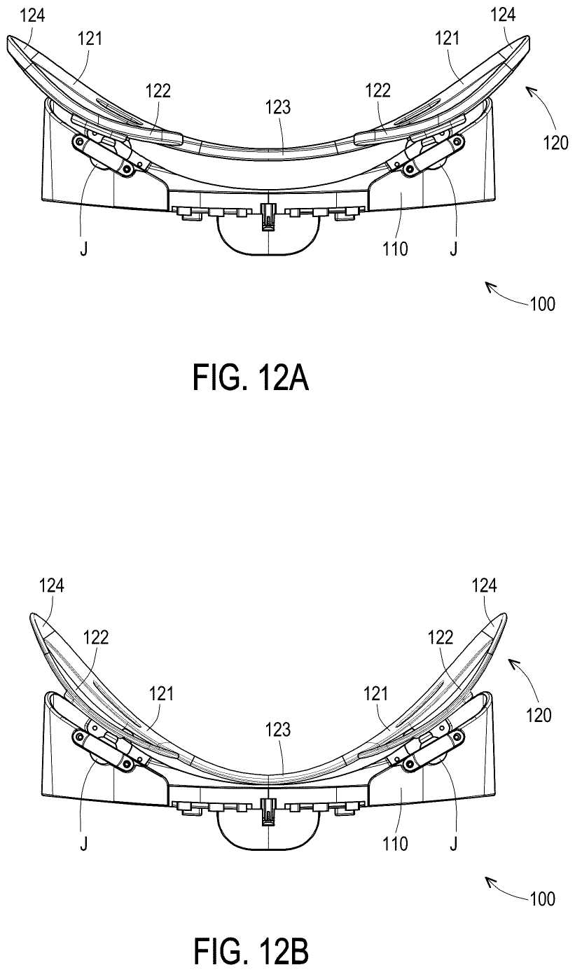

Referring to FIG. 10, FIG. 12 A, and FIG. 12B, different from the cheek connecting segment 122 of the pad 120 depicted in FIG. 3A, which is connected to the frame 110 with one rotational degree of freedom, in another embodiment, each of the pair of cheek connecting segments 122 of the pad 120 is movably connected to the frame 110 with three rotational degrees of freedom, so that the pad 120 may be adaptive to the user's cheeks. For example, each of the pair of cheek connecting segments 122 may be rotatably connected to the frame 110 via the ball joint J (as shown in FIG. 13 and FIG. 14), but the disclosure is not limited thereto.

Referring to FIG. 11A, FIG. 11B, FIG. 12A, and FIG. 12B, since each of the pair of forehead connecting segments 121 is movably connected to the frame 110 with three rotational degrees of freedom, and the pair of cheek connecting segments 122 is movably connected to the frame 110 with three rotational degrees of freedom, the upper and lower parts of the pad 120 may be adaptive to the user's forehead and cheeks respectively, thereby conforming to users with different face shapes.

Referring to FIG. 10, FIG. 13, and FIG. 14, similar to the forehead connecting segment 121 of the pad 120 depicted in FIG. 3A, which is connected to the frame 110 with another rotational degree of freedom and one translational degree of freedom, in the embodiment, each of the pair of forehead connecting segments 121 may also be movably connected to the frame 110 with another rotational degree of freedom and one translational degree of freedom. For example, each of the pair of forehead connecting segments 121 may have the slide rail T, and the bolt B passes through the slide rail T and is locked to the corresponding ball joint J, so that the sliding of the bolt B on the slide rail T adds another rotational degree of freedom and a translational degree of freedom between each forehead connecting segment 121 and the frame 110 to provide more margin when the pad 120 is deformed. Therefore, each forehead connecting segment 121 may be movably connected to the frame 110 with four rotational degrees of freedom and one translational degree of freedom through the ball joint J, the slide rail T, and the bolt B.

Referring to FIG. 10, FIG. 13, and FIG. 14, similar to the cheek connecting segment 122 of the pad 120 depicted in FIG. 3A, which is connected to the frame 110 with another rotational degree of freedom and one translational degree of freedom, in the embodiment, each of the pair of cheek connecting segments 122 may also be movably connected to the frame 110 with another rotational degree of freedom and one translational degree of freedom. For example, each of the pair of cheek connecting segments 122 may have the slide rail T, and the bolt B passes through the slide rail T and is locked to the corresponding ball joint J, so that the sliding of the bolt B on the slide rail T adds another rotational degree of freedom and a translational degree of freedom between each cheek connecting segment 122 and the frame 110 to provide more margin when the pad 120 is deformed. Therefore, each cheek connecting segment 122 may be movably connected to the frame 110 with four rotational degrees of freedom and one translational degree of freedom through the ball joint J, the slide rail T, and the bolt B.

To sum up, in the disclosure, the pair of forehead connecting segments and the pair of cheek connecting segments of the pad of the face gasket may each rotate relative to the frame to adapt to the face shapes of different users.

What is claimed is:

1. A head-mounted display device, comprising:
a display part;
a face gasket, comprising:
a frame, connected to the display part;
a pad, extending from a user's forehead, around user's eyes, and to user's cheeks, and having a pair of forehead connecting segments and a pair of cheek connecting segments, wherein the pair of forehead connecting segments respectively correspond to user's eyebrows and are each connected to the pad and rotatably connected to the frame with at least one rotational degree of freedom, and the pair of cheek connecting segments respectively correspond to the user's cheeks and are each connected to the pad and rotatably connected to the frame with at least one rotational degree of freedom.

2. The head-mounted display device according to claim 1, wherein the pad further has a forehead flexible segment and a pair of cheek flexible segments, the forehead flexible segment is located between the pair of forehead connecting segments, and each of the pair of cheek flexible segments is located at the corresponding forehead connecting segment and the corresponding cheek connecting segment.

3. The head-mounted display device according to claim 1, wherein each of the pair of forehead connecting segments is movably connected to the frame with two rotational degrees of freedom and one translational degree of freedom, and each of the pair of cheek connecting segments is movably connected to the frame with two rotational degrees of freedom and one translational degree of freedom.

4. The head-mounted display device according to claim 1, wherein each of the pair of forehead connecting segments is movably connected to the frame with three rotational degrees of freedom, and each of the pair of cheek connecting segments is movably connected to the frame with three rotational degrees of freedom.

5. The head-mounted display device according to claim 1, wherein each of the pair of forehead connecting segments is movably connected to the frame with four rotational degrees of freedom and one translational degree of freedom, and each of the pair of cheek connecting segments is movably connected to the frame with four rotational degrees of freedom and one translational degree of freedom.

6. The head-mounted display device according to claim 1, wherein the face gasket further comprises:
a foam layer, disposed on a side of the pad close to a user's face.

7. The head-mounted display device according to claim 1, wherein the face gasket further comprises:
a light shield, disposed between the frame and the pad.

8. The head-mounted display device according to claim 6, further comprising:
a headband module, connected to the display part.

9. A face gasket adapted for a head-mounted display device, wherein the head-mounted display device comprises a display part, and the face gasket comprises:
a frame, connected to the display part;
a pad, extending from a user's forehead, around user's eyes, and to user's cheeks, and having a pair of forehead connecting segments and a pair of cheek connecting segments, wherein the pair of forehead connecting segments respectively correspond to user's eyebrows and are each connected to the pad and rotatably connected to the frame with at least one rotational degree of freedom, and the pair of cheek connecting segments respectively correspond to the user's cheeks and are each connected to the pad and rotatably connected to the frame with at least one rotational degree of freedom.

10. The face gasket according to claim 9, wherein the pad further has a forehead flexible segment and a pair of cheek flexible segments, the forehead flexible segment is located between the pair of forehead connecting segments, and each of the pair of cheek flexible segments is located at the corresponding forehead connecting segment and the corresponding cheek connecting segment.

11. The face gasket according to claim 9, wherein each of the pair of forehead connecting segments is movably connected to the frame with two rotational degrees of freedom and one translational degree of freedom, and each of the pair of cheek connecting segments is movably connected to the frame with two rotational degrees of freedom and one translational degree of freedom.

12. The face gasket according to claim 9, wherein each of the pair of forehead connecting segments is movably connected to the frame with three rotational degrees of freedom, and each of the pair of cheek connecting segments is movably connected to the frame with three rotational degrees of freedom.

13. The face gasket according to claim 9, wherein each of the pair of forehead connecting segments is movably connected to the frame with four rotational degrees of freedom and one translational degree of freedom, and each of the pair of cheek connecting segments is movably connected to the frame with four rotational degrees of freedom and one translational degree of freedom.

14. The face gasket according to claim 9, further comprising:
a foam layer, disposed on a side of the pad close to a user's face.

15. The face gasket according to claim 9, further comprising:
a light shield, disposed between the frame and the pad.
